(19) United States
(12) Patent Application Publication
(10) Pub. No.: US 2005/0263081 A1
(43) Pub. Date: Dec. 1, 2005

(54) System and apparatus for storing and organizing supplements

(76) Inventor: Jackie Dalchow, Mayer, MN (US)

Correspondence Address: Merchant & Gould P.C., P.O. Box 2903, Minneapolis, MN, 55402-0903, US

(21) Appl. No.: 10/839,199

(22) Filed: May 4, 2004

(51) Int. Cl. A01K 5/00

(52) U.S. Cl. 119/51.01

(57) ABSTRACT

A supplement storage and organizing system configured to make animal dietary supplements available in proximity to an animal confinement area such as a horse stall. A supplement storage system includes a receptacle having a cavity for receiving supplement material, a cover that is coupled to the receptacle, and a supplement identifier that is coupled to the receptacle. The supplement identifier provides information regarding at least one animal that is associated with the supplement organizing system. The supplement storage system may include a mounting system that has components for removably coupling the supplement storage system to a wall or other object proximate to the animal confinement area. Multiple receptacles may be mounted together to provide an organized storage system. Mounting components may be installed both in a horse stall and in a horse trailer to allow the receptacle to be selectively installed in the stall or the trailer.

### FIELD OF THE INVENTION

The present invention relates to systems, apparatus and methods for storing products for animals. The systems, apparatus, and methods have particular applications in storing and organizing supplements that are administered to animals

### BACKGROUND

Animals generally benefit from consumption of supplements as part of a healthy diet. Dietary supplements provide vitamins, minerals, or other substances that livestock need to grow and maintain good health.

Supplements are generally purchased in some kind of bulk container (i.e. a tub, pail or bag) and then measured out into individual doses. The bulk supplement container should be properly resealed every time it is opened to protect the supplements against the harmful effects of moisture, insects, animals or debris. Horses in particular are routinely fed supplements to support their health and promote good performance. Supplements may for example remedy or protect against a vitamin deficiency, provide nutrition for hair and coat maintenance, improve stamina, or aid in strengthening joints, tendons, and ligaments.

The amount of supplements administered typically varies from animal to animal. For example, an older animal may require different supplements and different dosages than a younger animal. Similarly, larger animals may require larger dosages than smaller animals. Dosages also vary based on other factors, including, but not limited to, species, activity level, injuries, sex, pregnancy and diet.

Inconsistent administration of equine supplements can dramatically lessen the supplements' effectiveness. It is therefore important that supplements be administered consistently and in proper dosages. It is also important to restrict an animal's intake of both supplements and feed to avoid over-consumption. If an animal over-consumes, it may become sick or even die.

It is thus important to the animal's health that supplements and dosages be administered properly and stored safely. This can be a challenge, however, when many animals are boarded in a single location and when caretakers are not fully knowledgeable about the particular needs of each animal. To protect against over-consumption, supplements and animal feed are typically stored in a location that is inaccessible to the animals, such as a locked room. Bulk supplement containers are sometimes stored, for example, on the floor. This is generally not desirable because, inter alia, the bulk containers are more vulnerable to spoilage and infestation and the bulk containers can create a tripping hazard for animals such as horses.

Improved systems and methods of storing and organizing supplements are needed.

### SUMMARY

One embodiment of a supplement storage system for providing an animal dietary supplement in proximity of an animal confinement area includes a supplement receptacle, a cover, and a mounting system for coupling the supplement receptacle to an object proximate to the animal confinement area. The receptacle has at least one inner surface and an outer surface. The inner surface defines a cavity for receiving supplement material. The cover may be coupled to the receptacle. In one embodiment, the cover is removably coupled to the receptacle and is sealable to the receptacle to prevent contamination of the supplement material. The mounting system may include a first component that is configured to be secured to the object, and a second component that is coupled to the receptacle. The first and second mounting components have portions that permit the first component to be coupled to the second component. The second component of the mounting system may be permanently connected to the supplement receptacle, but could also be removably coupled to the receptacle. In one embodiment, an I-shaped beam is provided on a back side of the receptacle and a bracket having an I-shaped slot receives the I-beam.

The system may further include a dispenser, such as a scoop, for administering a measured portion of the supplement. The dispenser may be stored in the receptacle. The system may also include a supplement identifier. In one embodiment, the supplement identifier is coupled to the receptacle. The supplement identifier provides information regarding at least one animal that is associated with the supplement storage system. The supplement identifier may be an identification card that slides into a sleeve which is adhered or coupled to the receptacle or cover. The sleeve may be secured to the top side of the cover.

The supplement storage system may be secured to a variety of objects, including but not limited to a stall, a kennel, or an animal trailer. The supplement receptacle may be removably coupled to an object proximate to an animal confinement area to allow for easy access near the animal.

Another embodiment of a supplement storage system includes a plurality of supplement storage receptacles, the supplement storage receptacles each having a supplement reservoir for storage of supplement material, a sealing means for sealing the supplement material in the reservoir to protect the supplement material against contamination or infestation, an identification means for providing information about the contents of the supplement reservoir, and at least one mounting means for removably mounting the plurality of supplement storage receptacles in the general proximity of one or more designated animals. The mounting means may comprise a mechanical restraint for receiving a supplement storage receptacle or a magnetic coupling system. The system may further include a supplement dosing apparatus, such as a scoop, for measuring a volume of dietary supplement and transporting the dietary supplement to a feed area. An organized system may be achieved by mounting multiple storage receptacles together.

In another embodiment, a method of organizing dietary supplement for animals in proximity to an animal confinement area includes providing a supplement receptacle comprising having at least one reservoir for storing supplement material and mounting the supplement receptacle to an object proximate to an animal confinement area. A first component is secured to the object and a second component is coupled to the receptacle. The first component may be coupled to a second component to removably mount the supplement receptacle to the object.

In another embodiment, a supplement storage system for selectively providing an animal dietary supplement in proximity of an animal confinement structure or in an animal trailer includes at least one supplement receptacle having an inner surface and an outer surface, the inner surface defining a cavity for receiving supplement material. A first mounting system for removably coupling the supplement storage system to an object proximate to the animal confinement structure includes a first component that is configured to be secured to the object and a second component that is coupled to the receptacle. The first component and second component have mating parts that permit the first component to be coupled to the second component to removably mount the supplement receptacle to the object. A second mounting system for removably coupling the supplement storage system to the trailer includes a third component that is configured to be secured to the trailer and the second component that is coupled to the receptacle. The third component and second component have mating parts that permit the third component to be coupled to the second component to removably mount the supplement receptacle to the trailer.

In another embodiment, a supplement storage system for providing an animal dietary supplement in proximity of an animal confinement area includes at least one supplement receptacle having at least one inner surface and an outer surface, the at least one inner surface defining a cavity for receiving supplement material. A cover may be coupled to the at least one receptacle. A mounting system couples the at least one supplement receptacle to an object proximate to the animal confinement area to make the supplement easily available at the animal confinement area and safely secure the supplement. A supplement identifier couples to the receptacle, cover, or another object proximate to the animal confinement area. The supplement identifier provides information that identifies at least one animal that is to receive supplement from the supplement storage system.

### BRIEF DESCRIPTION OF THE DRAWINGS

FIG. 1 is a perspective view of three supplement storage systems constructed in accordance with the principles of the present invention.

FIG. 2 is a perspective view of portions of animal stalls with supplement storage systems mounted to the wall.

FIG. 3 is a front view of a supplement receptacle and cover constructed in accordance with the principles of the present invention.

FIG. 4 is a top view of the supplement receptacle and cover of FIG. 3.

FIG. 5 is a side view of a supplement receptacle engaged in a track.

FIG. 6 is a back view of the supplement receptacle of FIG. 5.

FIG. 7 is a top view of the receptacle of FIG. 5

FIG. 8. shows front view of a track constructed to receive the supplement storage system of FIGS. 3-6.

FIG. 9 is a side view of a cover.

FIG. 10 is a perspective view of a supplement receptacle.

FIG. 11 shows a scoop for measuring supplement.

FIG. 12 shows one embodiment of a supplement identifier.

FIG. 13 is a side view of an embodiment of a supplement storage system.

FIG. 14 is a top view of the supplement storage system of FIG. 13.

FIG. 15 is a back view of the supplement storage system of FIG. 13.

FIG. 16 is a front view of a mounting bracket for use with the supplement storage system shown in FIG. 13.

FIG. 17 is a top view of the mounting bracket of FIG. 16.

FIG. 18 is a partially cut-away side view of the mounting bracket of FIG. 16.

### DETAILED DESCRIPTION OF THE PREFERRED EMBODIMENT

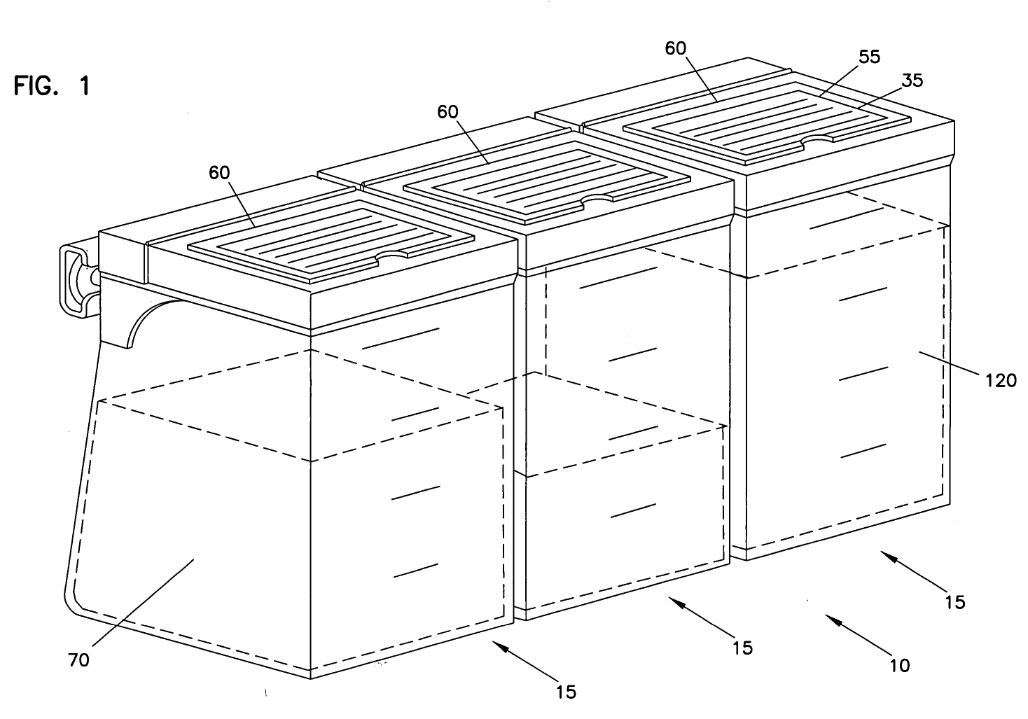

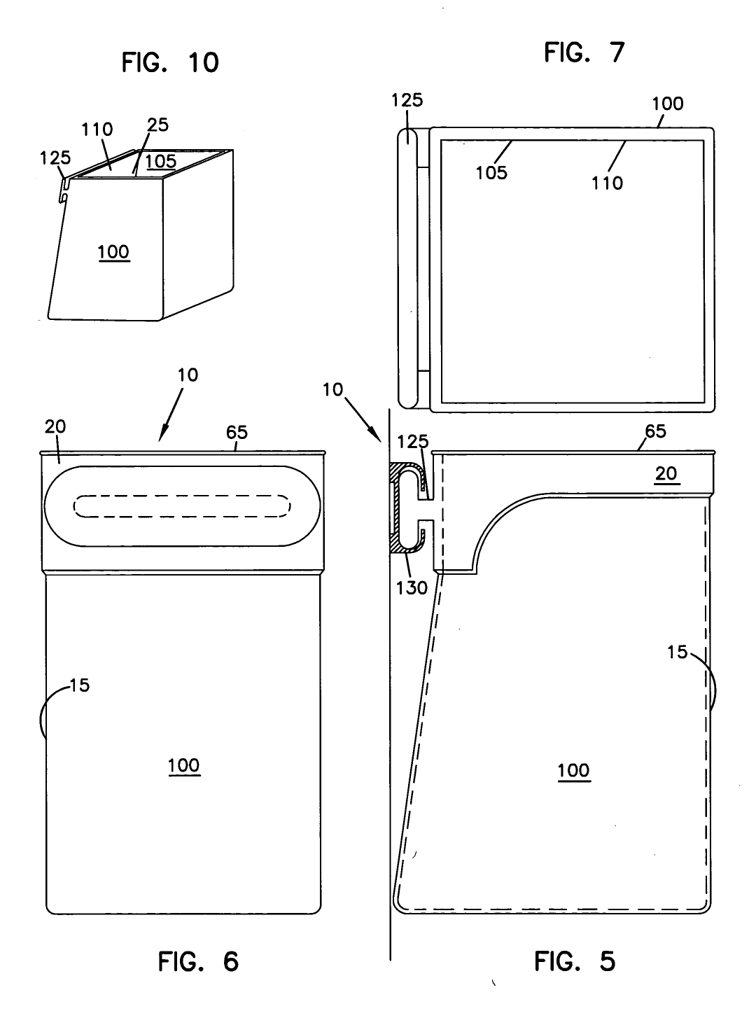

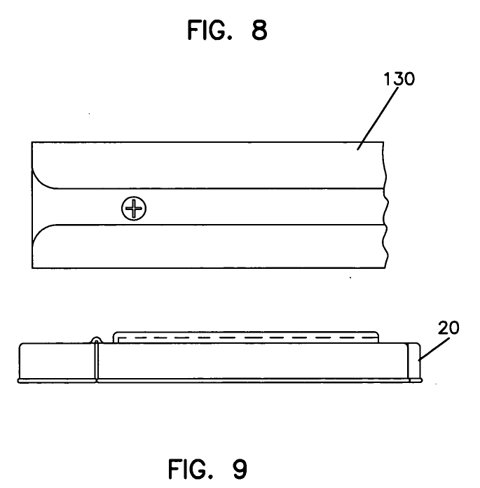

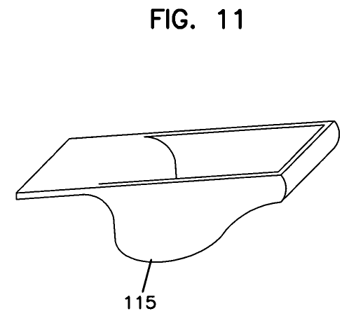

A supplement storage system 10 according to the present invention is shown in FIGS. 1-9. As shown in FIGS. 1 and 2, the supplement storage system 10 allows for storing and organizing supplements in proximity to an animal stall. Embodiments of the present invention are generally described with respect to stalled horses, but use of the system in livestock trailers or other applications is possible.

FIGS. 1-6 show an embodiment of a supplement storage system 10 constructed in accordance with principles of the present invention. A supplement receptacle 15 is assigned to a particular horse and mounted to a wall or other object in the vicinity of the horse's stall. The supplement receptacle 15 provides a secure and convenient storage location for supplement 70 in proximity to the stall for a designated animal.

The supplement storage system 10 preferably includes a measuring device 115 such as a scoop for measuring out doses of a supplement. At predetermined intervals, a specified amount of supplement (i.e. two scoops) is measured and fed to the designated animal according to feeding instructions which are available on the supplement receptacle, as shown for example on the supplement identifier in FIG. 7.

The present system promotes accurate administration of supplements and helps reduce the opportunity for error by human caretakers. One opportunity for human error is in the process of identifying the proper supplements for a particular animal. Each time a supplement is administered, there is a chance that a caretaker will identify the wrong supplement or forget a supplement. Prior to the present supplement storage system 10, the general practice has been to identify and allocate supplements 70 for particular animals at daily feeding times. In contrast, with the present system, the supplement-matching process occurs only when the receptacle 15 is filled with supplement. Because the supplement receptacle holds multiple doses of supplement, the identification of supplements occurs on a weekly or monthly basis, rather than daily. The system thus allows for better control of the administration of supplements because the process of matching supplement to animal occurs less often.

Another opportunity for error is in the process of delivery of a particular supplement to a particular animal. Prior to the present supplement storage system, the general practice has been to measure out supplements in a central location and then transfer the supplements to particular animal stalls. The transfer of supplements from a central location to particular stalls presents an opportunity for human error, i.e., erroneous delivery to the wrong stall. The present system reduces the opportunity for delivery error because each supplement is available directly at the stall of the animal that is supposed to receive that supplement. This reduces the likelihood of delivering the supplement to the wrong animal.

The present system also promotes accurate dosing of supplements. A measuring device such as a scoop 115 allows for easy measuring at the stall. Feeding instructions are provided on the receptacle or lid to promote accurate administration of the supplement.

The in-stall availability of supplements is particularly advantageous in large stables with rotating staff who may not be familiar with the needs and characteristics of each animal and the prescribed qualities of each supplement. Moreover, when a substitute caretaker is relied upon to feed an animal, it can be expected that the animal will receive the correct supplement and dose at every feeding, because the system eliminates the need for selecting and measuring the supplements. As previously described, the supplements are pre-selected and mounted at the stall, and the measurement is accomplished with the scoop.

As shown in FIG. 2, the supplement storage system 10 is designed to be mounted to the stall to provide convenient and safe access to supplements, in close proximity to the animal. In contrast to the present system, prior supplement storage systems are not well suited for storage in or near stalls. For example, the buckets in which supplements are commonly delivered may raise a safety hazard if stored on the floor around animals.

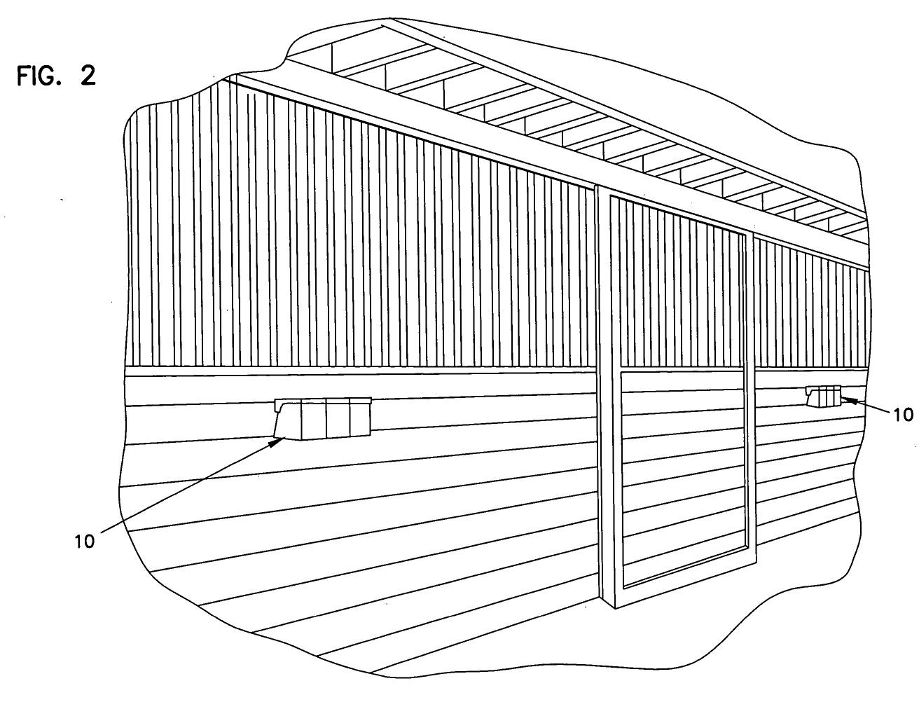

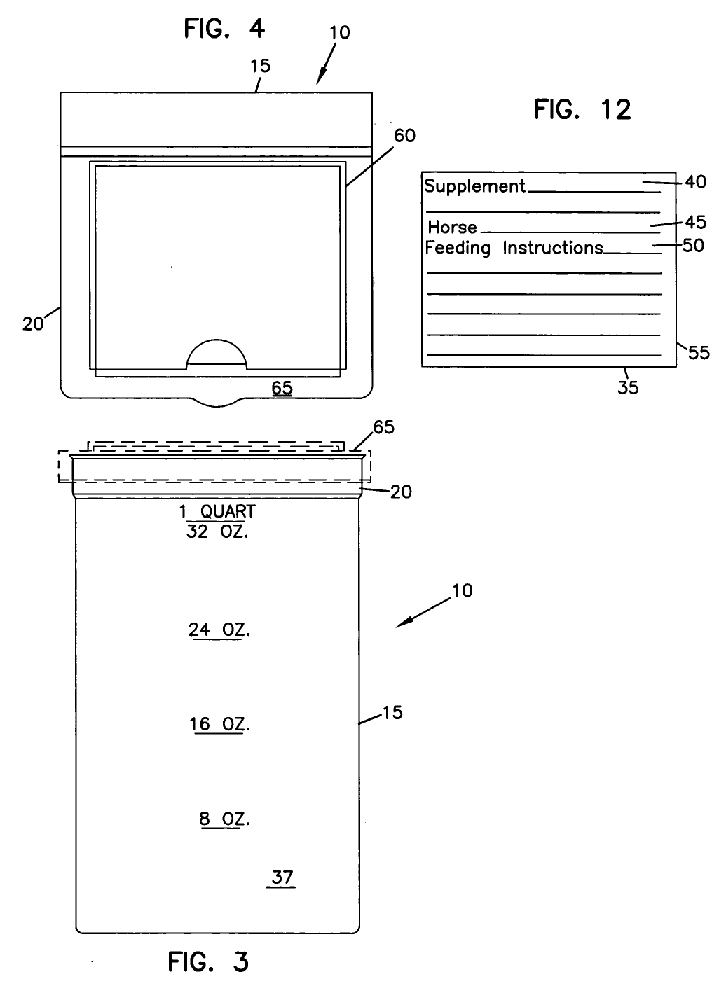

As shown in FIGS. 2 and 3, the supplement storage system 10 includes a receptacle 15 for holding the supplement and a lid 20 for covering the receptacle. The construction of the supplement storage system 10 should be robust enough to withstand the environment of a stable.

To avoid contamination of the supplement with dirt, dust, moisture, insects or animals, it is preferred that the cover 20 and receptacle 15 form a sufficient seal to provide the desired protection against contamination and infestation. The quality of the seal desired may vary depending on the particular application and the particular supplement that is stored in the receptacle. A seal may be achieved for example through a snap-fit between the lid and the top edge 25 of the receptacle, or by use of an O-ring through methods known to one skilled in the art. The seal may also be achieved using a cover with a clasp, a screw-on cover, or other methods known to those skilled in the art. In some applications or environments, it may not be necessary to provide a seal between a cover structure and the receptacle.

In one embodiment, a lid flips up to allow access to the supplement and supplement scoop. The lid may include a hinge portion that allows a portion of the lid to flip up. Alternatively, the lid may be attached to the stable and the supplement may be accessed by removing the receptacle from the lid.

As shown in FIG. 7, a supplement identifier 35 is provided for conveying information about the supplement contained in the receptacle 15. In a preferred embodiment, the supplement identifier provides a space 40 for the name of the supplement (or some other identifying symbol), a space 45 for the identity of the animal for which the supplement is provided, and a space 50 for the feeding instructions (i.e., the dosage) for the animal. The supplement identifier may also include other information such as information identifying the owner of the horse or a bar code that corresponds to further information.

In a preferred embodiment, the supplement identifier 35 is a paper card 55. Preferably, a sleeve 60 is provided on the top side 65 of the lid 20 for receiving the card 55. In one embodiment, the sleeve 60 is formed from transparent plastic and attached to the lid 20. The sleeve 60 protects the card from damage or corrosion while allowing the text on the card to be read through the plastic.

The supplement identifier 35 is preferably positioned in a manner and location to make it easy to read, thereby reducing the occurrence of mistakes in administering supplements. The location of the supplement identifier 35 on top of the lid 20 contemplates placement of the supplement storage system 10 below eye level. Alternate mounting configurations—for example at eye level or above eye level—make it desirable to locate the supplement identifier 35 in a different location, such as the front face 37 of the receptacle to allow for easy and ready access by a caretaker who needs to read the information on the identifier.

Alternate embodiments of the supplement identifier are possible. For example, the supplement identifier 35 may be provided in the form of an adhesive label that is adhered to the supplement storage system 10. An electronic display may also be desired in some circumstances.

As shown in FIGS. 3-6, the receptacle 15 has a plurality of outer surfaces 100 and an inner surfaces 105. The inner surfaces define a cavity 110 for holding the supplement, which is usually in granular or powered form.

Supplement is administered using a measuring device such as a scoop 115 to promote accurate doses. The scoop is sized to provide a particular amount of supplement. This permits the supplement to be administered in easily-measured amounts (i.e. 1 scoop, 2 scoops, etc.) Typically, the supplement is mixed with the animals feed. The size of the scoop may vary depending on the type of supplement being administered and the animal receiving the supplement.

In one embodiment of the present invention, the scoop 115 is stored inside the receptacle 15, although other arrangements are possible. Storing the supplement scoop with the supplement storage system 10 promotes accurate dosing because each supplement scoop stays with its designated supplement container. Locating a measuring scoop at the stall also saves time for those who might otherwise need to plan out and pre-measure supplements for the week.

In a preferred embodiment, the cavity 110 is large enough to receive a human hand. This allows for easy use of the scoop to retrieve supplement for administration to an animal. In addition, the receptacle is preferably sized to store enough supplement to last for a particular time interval—for example a week's supply or a month's supply, depending on the circumstances.

In one embodiment, the supplement storage system 10 cooperates with pre-measured supplement systems, such as SMARTPAK EQUINE® supplements. These types of products are typically purchased from a third party vendor that pre-measures brand-name supplements into containers for daily, weekly, or monthly use. The supplement storage system may be sized to receive a particular dosage or multiple dosages.

The supplement storage system 10 preferably includes a contents indicator 120. The contents indicator 120 allows for monitoring of the receptacle contents so that it may be refilled as necessary. In one embodiment, the receptacle is formed from transparent or translucent material that permits visual inspection of the contents, as shown in FIG. 1. Alternatively, a “see-through” stripe may be provided on the receptacle to permit monitoring of supplement levels. While the contents indicator is shown on the front face 37, it could also be on the side. The preferred front face location of the contents indicator allows visual access to the indicator when receptacles are mounted side-by-side.

One structure for mounting the supplement storage system 10 to a stall is shown in FIG. 4 and FIGS. 8-9. The supplement receptacle 15 may be removably mounted to allow easy attachment and detachment so that the organizer may be removed, cleaned, and refilled as necessary. FIG. 4 shows a T-shaped element 125 extending from the back of the lid 20. The T-shaped element 125 slides within a track 130 that is mounted to a wall. The track has elements that extend around the T-shaped element 125 to couple the receptacle to the wall. The receptacle 15 and lid 20 may be moved laterally to slide the T-shaped element out of the track to uncouple the receptacle from the wall. While the system is shown with a preferred T-shaped element 125, other shapes may be used, along with an appropriately shaped matching track.

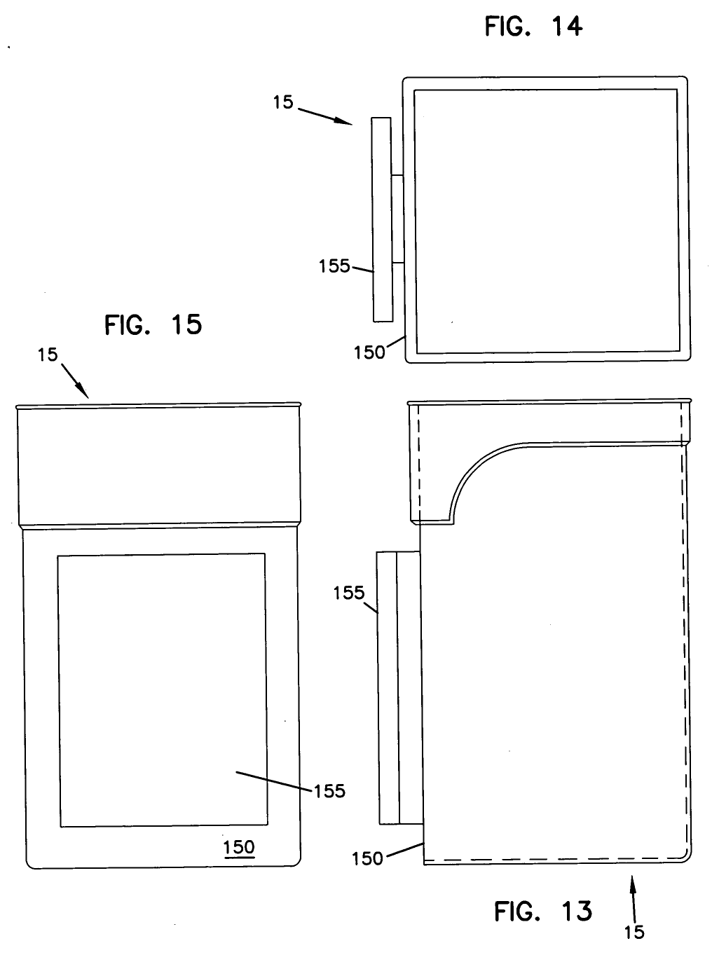

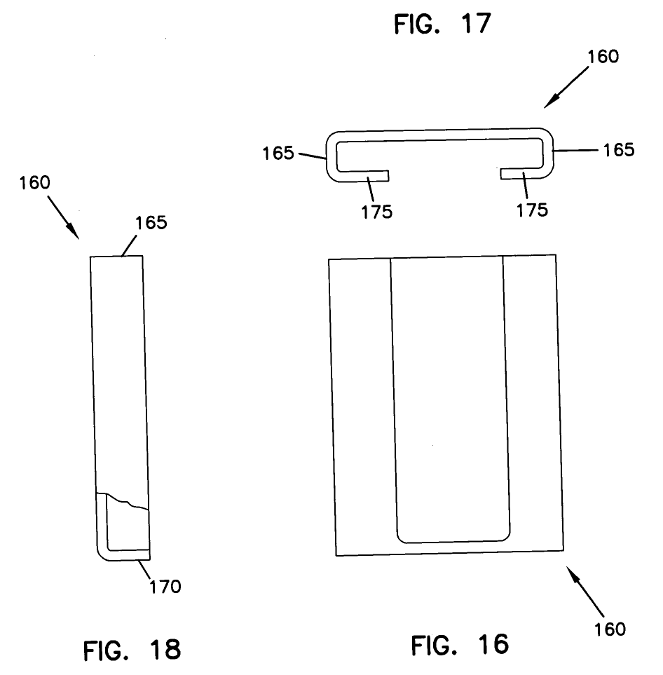

Another structure for mounting the supplement storage system 10 to a stall or other object is shown in FIGS. 13-18. A mounting component 155 runs vertically along the back side 150 of the receptacle 15. The mounting component 155 fits into a mounting bracket 160. The mounting bracket has side portions 165 that inhibit lateral movement of the receptacle 15 and a bottom portion 170 that inhibits downward movement of the receptacle. Front portions 175 inhibit movement of the receptacle 15 away from the bracket. This structure allows the receptacle 15 to be moved upwards out of the bracket to decouple the system from the wall or other object. If receptacles are mounted side-by-side, this structure has the advantage of allowing one receptacle to be removed from its mount without removing adjacent receptacles.

Another mounting structure uses a magnetic coupling system. A magnet is coupled to receptacle. In one embodiment, the magnet allows the system to be mounted to a ferromagnetic object. In another embodiment, a bracket is provided for mounting the receptacle. The bracket may incorporate a magnet, or alternatively may be constructed a ferromagnetic material or other appropriate material.

In one embodiment, multiple supplement storage systems 10 may be mounted together to organize multiple supplements for an animal, as shown in FIG. 1. In a preferred arrangement, supplement storage systems are mounted side-by-side as shown in FIG. 1. When the supplement identifier 35 is located on the top of the lid, this allows for easy identification of each supplement. Providing multiple supplement storage systems 10 furthers the goal of consistently providing animals with the correct supplements in the correct dosages.

In another embodiment, the supplement storage system 10 may be mounted in a trailer. Preferably, the supplement storage system is mounted in a tack room or dressing room in the trailer. To allow portability between a stall and a trailer, components may be provided that allow mounting of a receptacle at a stall or in a trailer. For example, components with matching mounting structures may be placed in both a stable and in a trailer, so that a supplement storage system can easily be removed from the stall and installed in the trailer.

The above specification, examples and data provide a complete description of the manufacture and use of the composition of the invention. Because many embodiments of the invention can be made without departing from the spirit and scope of the invention, the invention resides in the claims hereinafter appended.

1. A supplement storage system configured to provide an animal dietary supplement in proximity of an animal confinement area, the supplement storage system comprising:
a supplement receptacle having at least one inner surface and an outer surface, the at least one inner surface defining a cavity configured to receive supplement material; and
a mounting system configured to couple the supplement receptacle to an object proximate to the animal confinement area, the mounting system comprising a first component that is configured to be secured to the object, and a second component that is coupled to the receptacle, the first component and second component having portions that permit the first component to be coupled to the second component.

2. The supplement storage system of claim 1 further comprising a dispenser configured to measure a portion of the supplement.

3. The supplement storage system of claim 2 wherein the dispenser is stored in the receptacle.

4. The supplement storage system of claim 1 further comprising a supplement identifier that is coupled to the receptacle, the supplement identifier providing information regarding at least one animal that is associated with the supplement storage system.

5. The supplement storage system of claim 1 wherein the supplement identifier is an identification card.

6. The supplement storage system of claim 5 wherein the supplement storage system further comprises a sleeve that is coupled to the supplement storage system, the identification card being received within the sleeve.

7. The supplement storage system of claim 6 further comprising a cover structure configured to cover at least a portion of the cavity wherein the sleeve is secured to a top side of the cover structure, the identification card being readable when the supplement storage system is mounted to an object.

8. The supplement storage system of claim 1 further comprising a cover that is removably coupled to the receptacle to prevent contamination of the supplement material.

9. The supplement storage system of claim 1 wherein the object is selected from one of: a portion of a stall, a portion of a kennel, a portion or an animal trailer.

10. The supplement storage system of claim 1 wherein the supplement receptacle is removably coupled to the object proximate to the animal confinement area.

11. The supplement storage system of claim 1 wherein the second component of the mounting system is permanently connected to the supplement receptacle.

12. A supplement organizing system configured to organize dietary supplement materials that are allocated to a plurality of animals by locating particular supplement material in the general proximity of particular animals, the system comprising:
a plurality of supplement storage receptacles, the supplement storage receptacles each having:
a supplement reservoir configured to store of supplement material;
a sealing means for sealing the supplement material in the reservoir to protect the supplement material against contamination or infestation; and
an identification means for providing information about the contents of the supplement reservoir,
at least one mounting means for removably mounting the plurality of supplement storage receptacles in the general proximity of one or more designated animals; and
a supplement dosing apparatus for measuring a volume of dietary supplement and transporting the dietary supplement to a feed area.

13. The supplement organizing system of claim 12 wherein the mounting means comprises a mechanical restraint that is configured to receive at least a portion of supplement organizing receptacle.

14. The supplement organizing system of claim 12 wherein the mounting means comprises a magnet.

15. The supplement organizing system of claim 12 wherein the supplement dosing apparatus comprises a scoop.

16. A method of organizing dietary supplement in proximity to an animal confinement area, the method comprising:
providing a supplement receptacle comprising at least one reservoir configured to store supplement material; and
mounting the supplement receptacle to an object proximate to an animal confinement area by:
providing a first component that is secured to the object and providing a second component that is coupled to the receptacle, and
coupling the first component to second component to removably mount the supplement receptacle to the object.

17. The method of claim 16 further comprising providing a supplement identifier that is coupled to the supplement receptacle, the supplement identifier providing information regarding at least one animal that is designated to receive the supplement material that is stored within the supplement receptacle, the supplement identifier at least providing information identifying the at least one animal;

18. The method of claim 16 further comprising providing a supplement identifier that is located in the vicinity of the supplement receptacle, the supplement identifier providing information regarding at least one animal that is designated to receive the supplement material that is stored within the supplement receptacle, the supplement identifier at least providing information identifying the at least one animal.

19. The method of claim 16 wherein the supplement receptacle is removably mounted to the object proximate to an animal confinement area.

20. A supplement storage system configured to selectively provide an animal dietary supplement in proximity of an animal confinement structure or in an animal trailer, the supplement storage system comprising:
at least one supplement receptacle having an inner surface and an outer surface, the inner surface defining a cavity configured to receive supplement material;
a first mounting system configured to removably couple the supplement storage system to an object proximate to the animal confinement structure, the mounting system comprising a first component that is configured to be secured to the object, and a second component that is coupled to the receptacle, the first component and second component having mating parts that permit the first component to be coupled to the second component to removably mount the supplement receptacle to the object; and
a second mounting system configured to removably couple the supplement storage system to the trailer, the second mounting system comprising a third component that is configured to be secured to the trailer, and the second component that is coupled to the receptacle, the third component and second component having mating parts that permit the third component to be coupled to the second component to removably mount the supplement receptacle to the trailer.

21. The supplement storage system of claim 20 further comprising a supplement identifier that is coupled to the receptacle, the supplement identifier providing information regarding at least one animal that is associated with the supplement storage system;

22. The supplement storage system of claim 20, wherein the second mounting system is located in one of: a tack room or dressing room.

23. A supplement storage system configured to provide an animal dietary supplement in proximity of an animal confinement area, the supplement storage system comprising:
at least one supplement receptacle having at least one inner surface and an outer surface, the at least one inner surface defining a cavity configured to receive supplement material;
a cover that is configured to cover at least a portion of the cavity of the at least one receptacle;
a mounting system configured to couple the at least one supplement receptacle to an object proximate to the animal confinement area to make the supplement easily available at the animal confinement area and safely secure the supplement; and
a supplement identifier that is coupled to an object proximate to the animal confinement area, the supplement identifier providing information that identifies at least one animal that is to receive supplement from the supplement storage system.

24. The supplement storage system of claim 23 wherein the supplement storage system comprises at least two receptacles, the mounting system being configured so that a first receptacle can dismounted without dismounting other receptacles.
